(19) United States
(12) Patent Application Publication
(10) Pub. No.: US 2012/0233164 A1
(43) Pub. Date: Sep. 13, 2012

(54) MUSIC CLASSIFICATION SYSTEM AND METHOD

(75) Inventors: Robert Rowe, New York, NY (US); Jeff Berger, East Hampton, NY (US); Juan Bello, New York, NY (US)

(73) Assignee: Sourcetone, LLC, Southampton, NY (US)

(21) Appl. No.: 13/061,248

(22) PCT Filed: Sep. 8, 2009
(86) PCT No.: PCT/US09/05041

§ 371 Date: May 19, 2011

Related U.S. Application Data
(60) Provisional application No. 61/094,583, filed on Sep. 5, 2008.

(51) Int. Cl. G06F 17/30

(52) U.S. Cl. 707/737; 707/E17.046

(57) ABSTRACT

The present identifies collections of digital music and sound that effectively elicit particular emotional responses as a function of analytical features from the audio signal and information concerning the background and preferences of the subject. The invention can change emotional classifications along with variations in the audio signal over time. Interacting with a listener, the invention locates music with desired emotional characteristics from a central repository, assembles these into an effective and engaging “playlist” (sequence of songs), and plays the music files in the calculated order to the listener.

### BACKGROUND OF THE INVENTION

The present invention relates to a system and method for classifying music based upon its effect on a listener and for selecting music for a listener based upon achieving a intended effect on him.

Music can make us laugh or cry, it can frighten, surprise, retrieve forgotten memories, invite us to dance, or lull us to sleep. Music has the power to elicit a wide range of emotions, both conscious and unconscious, in the mind of the listener. This effect arises from the complex interaction of many individual elements of music such as dynamics (degree of loudness), tempo, meter (pattern of fixed, temporal units that overlay, or ‘group’ the steady beats), rhythmicity (ever-shifting combinations of impulses of varying length), melodic contour, harmony, timbre (tone color), and instrumentation. In addition, other, more difficult-to-control factors such as the predisposition, mood, cultural background, individual preferences, and personality traits of the listener must also be considered.

The field of music therapy has developed several major approaches to using music for the treatment of many forms of behavioral, cognitive, and emotional disorders. These can be classified into active and passive approaches, in terms of whether the patients are engaged in producing music themselves (active) or simply listening to it (passive). The Nordoff-Robbins approach is an example of active music therapy, in which patients learn to improvise by playing music together with highly trained therapists [Nordoff & Robbins 1977].

A defunct online service called MoodLogic attempted to construct playlists with particular emotional characteristics, but did this by collecting explicit user rankings for every track and did not make use of any audio analysis techniques [Gjerdingen et al. 2000].

An application called Moody organizes playlists according to mood, but relies on users manually entering all of the mood classifications [www.crayonroom.com/moody].

Several services offer playlists of music intended to induce a particular mood, but these are pre-constructed by the services and do not take individual differences into account. They are also not based on an automated analysis of any music, but rely on the subjective preferences of the author of the playlists [www.ez-tracks.com/Mood.html].

A research group at Microsoft has published and patented a technique for automatic mood estimation [Liu, Lu, & Zhang 2003; Lu, Liu, & Zhang 2006; Lu & Zhang 2006]. They use a hierarchical system in which an initial categorization is made based on intensity (loudness), followed by a second categorization using timbre and rhythm features. At the end of the process audio tracks are classified into one of four emotional categories: contentment, depression, exuberance, and anxious.

Yang, Lin, Su, and Chen [2008] describe a technique for finding a point in Thayer's two-dimensional emotion space by using regression to predict valence and arousal values from audio features.

To various degrees this prior art has sought to solve the problem of determining the optimal program of music to be presented to subjects in order to induce particular emotional states, tracking the changes in emotional response to that music over time, locating files on a central repository to produce a program with the desired emotional characteristics for a given subject or generically for the average subject, assembling those files into an effective and engaging order, and presenting the program to a listener.

However the problem has not been solved completely or effectively, because the solutions developed to date do not include information about subject demographics, musical history, preferences, and familiarity with music in their models; have not tested their approaches against a broad range of music and rigorously collected subject responses; do not track and predict changes in emotional response over time; do not have processes for searching a database and constructing an emotionally effective playlist; and are not able to render that playlist to a listener through use of an online emotion specification system.

Systems such as MoodLogic and Moody rely on user ratings to classify emotions, and so do not represent an automatic solution to the problem. The hierarchical system for music mood estimation developed at Microsoft [Lu & Zhang 2006] does automate the process, but does not take into account individual differences by modeling the listener through demographics, musical experience, preferences, and familiarity and does not model changes in emotion in a track over time. The regression-based system described in [Yang, Lin, Su, & Chen 2008] does predict an emotional response from audio features, but again does not take into account individual differences based on demographic and biographic information, does not change its evaluation of emotional content over time, and does not inform a playlist generation system.

### SUMMARY OF THE INVENTION

In accordance with one aspect, the present invention identifies collections of digital music and sound that effectively elicit particular emotional responses as a function of analytical features from the audio signal and information concerning the background and preferences of the subject. The invention can change emotional classifications along with variations in the audio signal over time. Interacting with a listener, embodiments of the invention locate music with desired emotional characteristics from a central repository, assemble these into an effective and engaging “playlist” (sequence of songs), and play the music files in the calculated order to the listener.

In accordance with another aspect, the present invention uses machine learning techniques to develop emotional classifications of music based on predefined, preferably three, elements: audio features; information about subject preferences, musical history, and demographics; and a set of continuous labels acquired from human subjects who reported their emotional responses to recordings of music while they auditioned the recordings. As new information arrives from a particular user interacting with the system, the classifier for that user is retrained to reflect the new data points. In this way classification for particular users, as well as for groups of users similar to the one providing the information, is continually refined and improved.

Preferably, an online interface allows listeners to select playlists that are predicted to have specific emotional qualities for that listener; to indicate emotional responses that differ from the predictions, allowing the personalized classifier to improve; and to rate, ban, and favor songs in such a way that playlists generated for that listener will reflect his personal preferences. The interface interacts with an online database, generating queries to the database that will produce playlists with the desired characteristics. New information coming from listeners as to their demographics, preferences, responses, and so on, is both added to the database and used to retrain a classifier for that listener. When the system has no information about a particular listener (as when a new listener logs on to the system for the first time), a generic listening model that represents the average response of subject responses from the tests conducted at BIDMC (Beth Israel Deaconess Medical Center, a teaching hospital of Harvard Medical School, where the emotional listening tests with human subjects were performed) is used until the listener begins providing personalization information.

The present invention is unique in that it adapts to new information from the user concerning his emotional responses and preferences. As a user continues to interact with the system, it learns more about his emotional responses and refines its predictions for that user accordingly.

The bulk of the work in music therapy is based on active participation of the subject, while the present invention assumes only listening as the means of delivery. The present invention achieves automatic estimation of mood perception from an audio signal and subject information.

Existing solutions all assume a universal emotional response to music—they produce the same prediction of emotional response no matter who the listener may be. The present invention differs significantly from this approach in that it assumes that an individual listener will vary in his emotional response, and it builds in a mechanism for collecting and learning to predict these individualized variations. No other known classification system does this. The system may have a presumed universal, or average, emotional model that is used when nothing is yet known about a particular listener, but this averaged model is supplanted whenever a user supplies additional information about himself

### BRIEF DESCRIPTION OF THE DRAWINGS

The foregoing brief description and further objects, features and advantages of the present invention will be understood more completely from the following detailed description of presently preferred, but nonetheless illustrative, embodiments in accordance with the present invention, with reference being had to the accompanying drawings in which:

FIG. 1 is a block diagram illustrating the training phase of a preferred embodiment in accordance with the present invention;

FIG. 2 is a block diagram illustrating the operation phase of a preferred embodiment in accordance with the present invention;

FIG. 3 is a block diagram illustrating the updating phase of a preferred embodiment in accordance with the present invention;

FIG. 4 is screen print of a preferred online user interface permitting playing and emotional evaluation of music;

FIG. 5 is a block diagram of a preferred full system embodying the present invention;

FIG. 6 is a screen print of a preferred “emotional wheel” user interface permitting a listener to rate the emotional effect of music being heard;

FIG. 7 is a graph illustrating the variation with time of a listener's emotional response as he listens to a piece of music being played;

FIG. 8 is a graph, in the form of a three-dimensional LDA projection, illustrating how a listener's emotional response to music resolves to five different mood classes;

FIG. 9 is a bar graph showing, by age group, how often listeners said they preferred a song highly, even though they were unfamiliar with it; and

FIG. 10 is a graph illustrating how a listener tends to rate the valence (positive/negative effect) of a song as a function of his familiarity with it.

### DETAILED DESCRIPTION OF THE PREFERRED EMBODIMENTS

As used herein “classification” of music is intended to describe the organization of musical performances into categories based on an analysis of its audio features or characteristics. “Performance” will be understood to include not only a complete musical performance but also a predefined portion of a full performance. In the case of the present invention, one or more of the categories relates to the effect of the musical performance on a human listener. “Classification” may include sorting a performance into a predetermined number of categories, as well as regression methods that map a performance into a continuous space, such as a two-dimensional space, in which the coordinates defining the space represent different characteristics of music. A support-vector machine may be used to train a classification version of the invention, while a support-vector regression may underlie a regression.

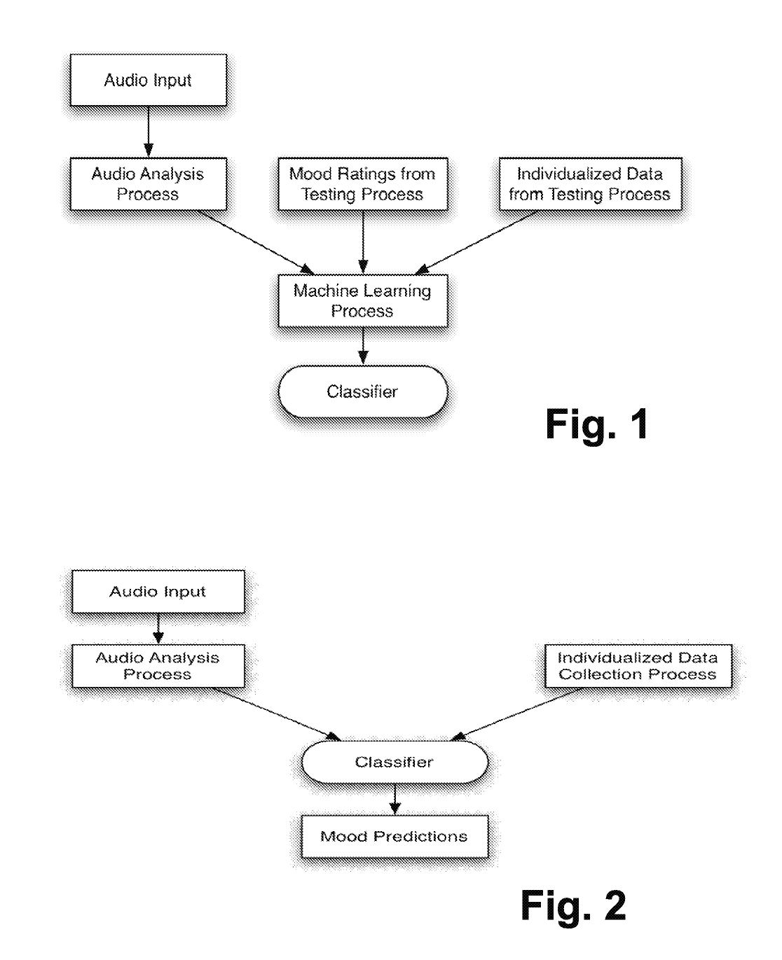

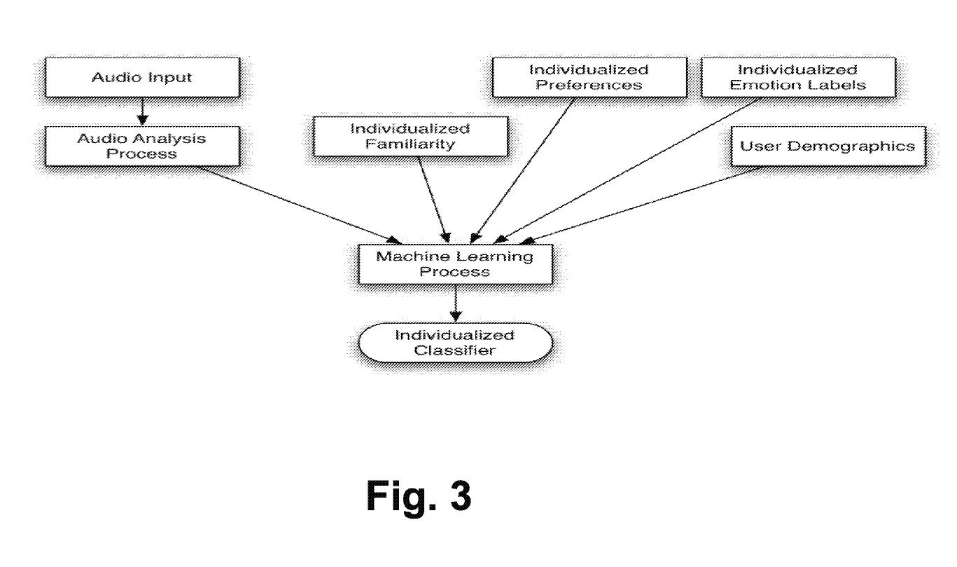

Preferably, a system in accordance with the present invention comprises at least one processor which performs an audio analysis process; an individualized data collection process; a machine learning process; and a playlist generation process. These processes, as illustrated by block diagrams, are invoked during three distinct phases of operation: the training phase (FIG. 1), the operation phase (FIG. 2), and the updating phase (FIG. 3).

An audio analysis process derives descriptive features from an audio input signal representing digitally recorded music, sound, or spoken dialog: these input signals are depicted in FIG. 1 as “Audio Input.” Audio feature analyses include spectral processing, temporal processing, and an analysis based on a model of the human auditory system. The feature descriptions output from these analyses form part of a record describing each audio file known to the system (also referred to herein as MCST). Appendix A describes the features currently computed by the system for the audio analysis process.

The classifier is a machine learning process that is automatically trained to group audio files according to the distribution of features recognized in the audio analyses, and the demographic characteristics of subjects as well as their musical experience and preferences, such that the audio file groups correspond to the predicted emotional experience of a given subject for those files.

For example, the classifier can predict that a group of files would be labeled ‘happy’ by a given listener whose personal information is known to the system. When the system does not have sufficient information about a given individual it makes generic emotional predictions based on the average responses of all subjects who were tested or have supplied emotional tags online.

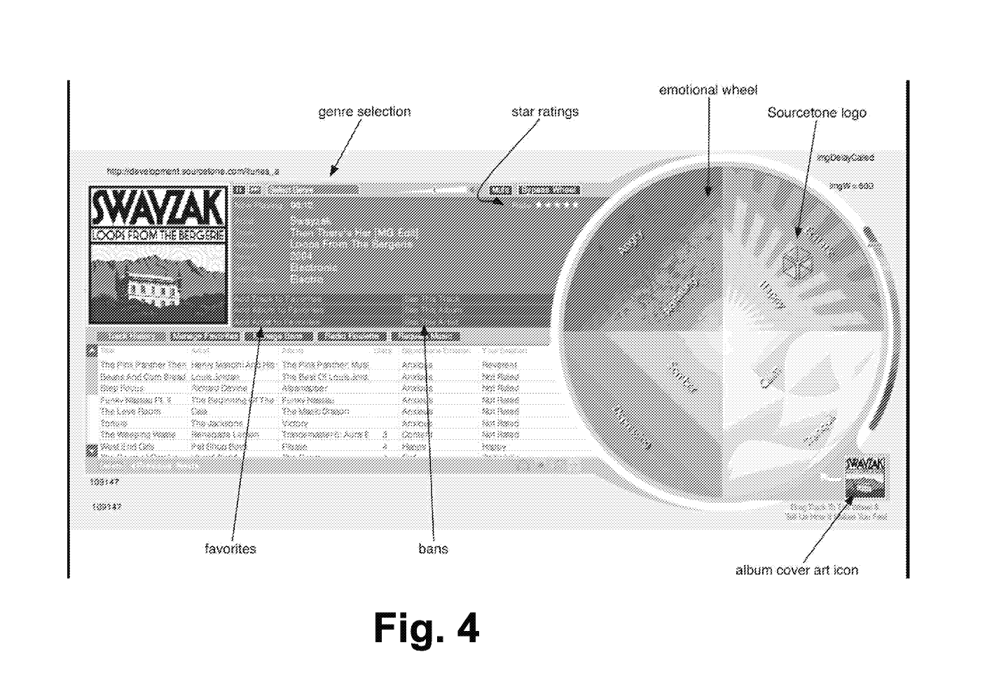

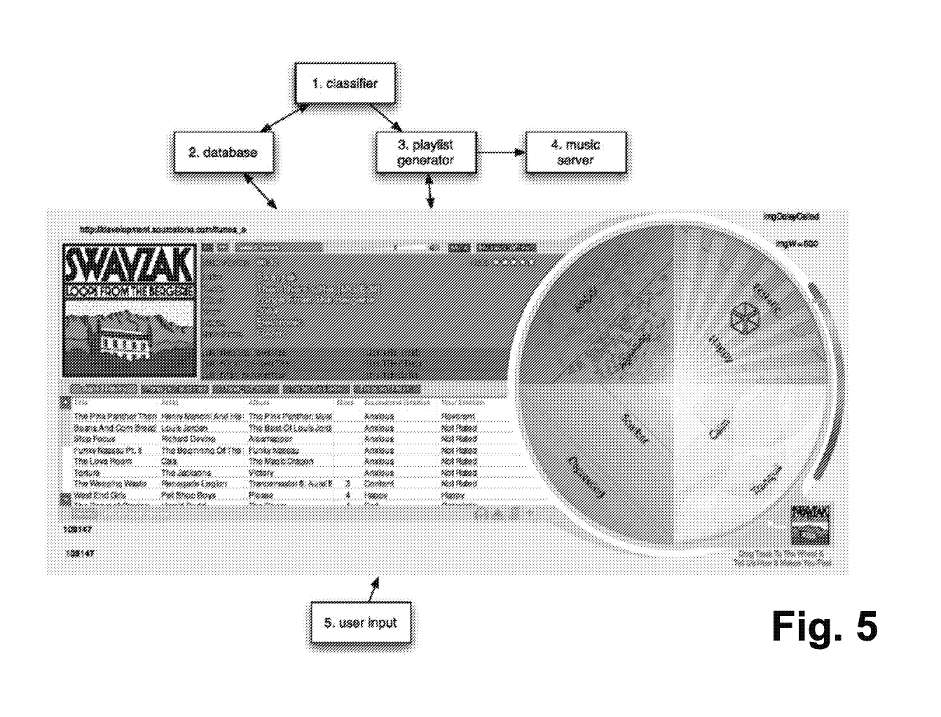

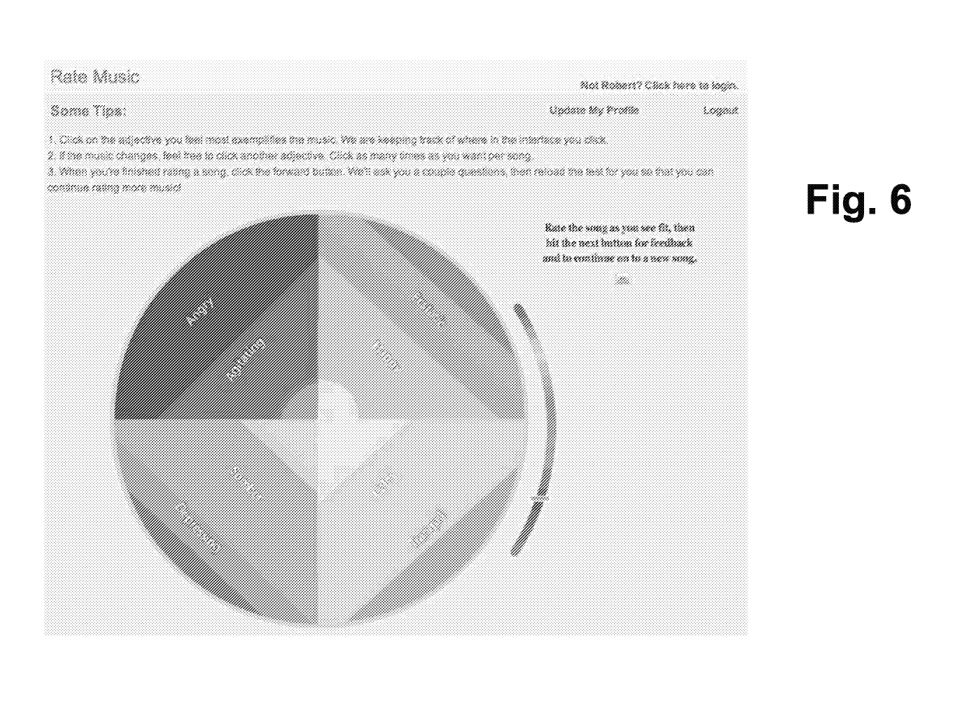

The machine learning process is preferably trained using data collected from a set of experiments conducted by researchers at Beth Israel Deaconess Medical Center (BIDMC) in Boston, as well as data collected online from subjects interacting with a web-based version of the same test (FIG. 6), or who make indications of emotional response on a radio interface (FIG. 4).

FIG. 1 is a block diagram illustrating the training phase of the classifier. Analysis records consisting of vectors of values for the audio features listed in Appendix A are labeled with emotional responses collected from the subjects who participated in the BIDMC studies, or online. Further, subjects are characterized by demographic and other musical (e.g. years of lessons on a musical instrument), emotional (e.g. completion of a normed visual imagery test), and educational (e.g. highest level of formal education completed) information that was collected by BIDMC, or online. The testing methodology bears some similarity to work reported in [Schubert 2004], but goes much further in using a broader range of music for testing, a larger and more sophisticated set of feature detections for characterization of the audio signals, and an extensive set of demographic and other information about each subject.

The machine learning process is a support vector machine that is trained through supervised learning. The learning process iterates through the labeled examples until it reaches an optimal condition of matching the audio features and user demographics to the given labels. The output of the machine learning process is a classifier that takes as inputs vectors of audio features and user information. For a given audio feature vector and set of user information, the classifier will predict that user's emotional response to the audio represented by the feature vector. Support vector machines are a standard part of machine learning and are widely described in the literature [Smola & Schölkopf 2004].

The output of the machine learning process is a classifier (software process) that can predict emotional responses given vectors of audio features and information about the listener. The classifier is best seen as an extension of the support vector machine described above, as it is the output from that process that has been trained to predict outputs relative to regularities in the audio feature and subject information inputs. Therefore, in the operation phase (FIG. 2), audio files will be related to the proper emotional predictions by supplying audio features and user demographics to the classifier, which then will respond with the predicted emotion for that user as learned from the training examples.

For example, one expression of the MCST uses an Internet streaming music service that is controlled through the user interface shown in the screen print of FIG. 4. In the operation phase of the service, users click in the circle with emotional adjectives (“emotional wheel”) to initiate playback of a new stream of songs that are predicted by the MCST to have the requested emotional quality for that user. The emotional wheel implements a version of Thayer's two-dimensional emotion space [Thayer 1989], where arousal (calm/exciting) and valence (positive/negative) are the dimensions used to bound the space.

When a user first begins to interact with the system, the singular emotion label given to any particular track reflects the average of ratings given to that track or similar tracks by the subjects in the tests at BIDMC or online. During the training phase, each track is divided into five-second segments. Because subjects in the BIDMC tests rated songs continuously, the learning algorithm has access to all of the subjects' emotional labels for each five-second segment of every song. These segments are then used to train the classifier to recognize the emotions indicated by the subjects as correlated to the feature vectors for those segments.

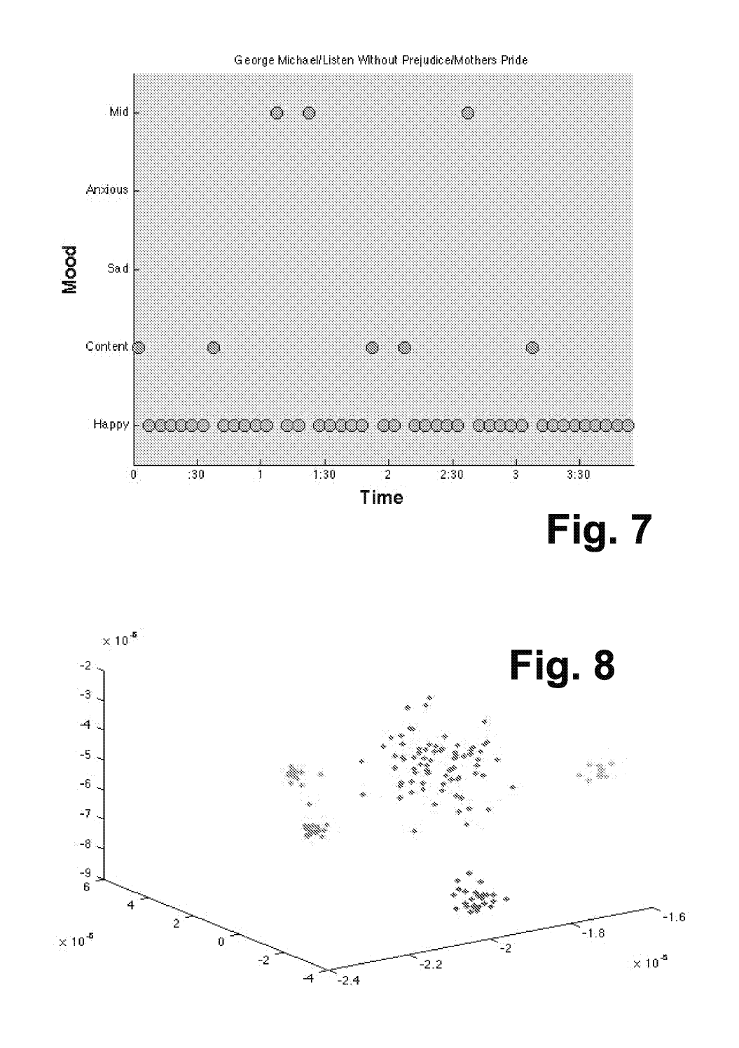

Subsequently, in the operation phase (FIG. 2), tracks being classified are similarly cut into five-second segments. Each segment is classified individually, and recorded into a time-varying representation of the emotional trajectory of the song (see the graph of FIG. 7, depicting a time-varying prediction of emotional response produced by the embodiment). The time-varying representation is used to predict changes in the emotional response to a particular song over time. For overall ratings of the entire song, the classifier takes the sum of weightings for each of the five classes during all of the five-second segments to derive a single emotional distribution for the entire song.

The nature of the classification of each five-second segment will now be examined in more detail. First of all, the segment formation rule is currently set to five seconds, but may be any consistent duration. The classifier output after the training phase produces for each segment a probability distribution across five classes: high valence/high arousal (happy); high valence/how arousal (content); low valence/high arousal (anxious); low valence/low arousal (sad); and neutral (no predominant values for either valence or arousal). Each segment receives a five-value distribution of energy across these five classes, such that the sum of all five is equal to one. For example, one segment might be valued as 0.6 happy (60%), 0.1 content (10%), 0.1 anxious (10%), 0.1 sad (10%), and 0.1 neutral (10%). Such a segment would be classified as predominantly happy. For an entire song, the probability distributions for all five-second segments are summed to provide a distribution for the song overall, and the most heavily weighted class from that sum is taken as the overall emotional classification for the track.

In the update phase (FIG. 3), new data arriving from a user's interaction with the song player is used to retrain the classifier with information specific to that user (FIG. 3). That is, a support vector machine is retrained using the same audio features listed in Appendix A, but with new emotional labels provided by an individual user in addition to those coming from the BIDMC tests and other users who have entered data online. When that user interacts with the MCST subsequently, it will respond with emotional predictions based on a personalized classifier trained by data taken predominantly from that user for songs the user has rated, along with other classifications taken from the larger pool of users for songs that that particular listener has not individually rated.

Online users have multiple opportunities to provide information about themselves, their musical preferences, and their emotional responses. The star rating function on the user interface (FIG. 4) records preference levels for individual songs (shown as “Individualized Preferences” in FIG. 3). While listening to songs selected by the classifier, the user may at any time indicate that a song has, for them, a different emotional quality than that predicted by the MCST. The predicted emotion is indicated on the emotional wheel by the Sourcetone logo (FIG. 4). The user may indicate his own emotional response to a track by dragging the album cover art icon to the emotional wheel and onto the adjective or area corresponding to his own emotional rating.

This will update the database with the appropriate emotion for that track for that user, and retrain the user's classifier accordingly. The “favorites” and “bans” section of the interface gives users another way to control their playlists and indicate their preferences. When the user designates a track, artist, or album a favorite, the play listing algorithm will increase the likelihood of that track, album, or artist being added to playlists for that user. When the user bans a track, artist, or album, the play listing algorithm will not add that track, or others from that artist or album (if those were indicated) to playlists targeted to that user.

Further, the Internet song player interface provides multiple opportunities for users to enter information about themselves, equivalent to the demographic and background questions asked during the BIDMC tests (shown as “User Demographics” in FIG. 3). The system also permits users to indicate their level of familiarity with any given song (shown as “Individualized Familiarity” in FIG. 3). All of this information is recorded into a database of information about each user and input to the support vector machine to retrain a personalized classifier for that user that will more accurately predict the emotional responses of that user than the generalized classifier would.

When a user clicks on an emotion in the emotional wheel, a play listing algorithm is used to continually select songs to play for that user over his Internet connection. Several factors taken together determine which song will be selected for playback to a given listener at any given time:

selected emotion

selected genre

artist, album, and track favorites

artist, album, and track bans

the user's personalized classifier (if one exists)

the generic classifier

predicted familiarity

When the user clicks on an adjective in the emotional wheel, the point on the wheel that was indicated is used to select a song with a distribution function that places it most closely to the indicated point. For example, clicking on a point 45° from the top of the wheel in the “happy” quadrant would select a track whose probability distribution indicated emotional content that was concentrated almost entirely in the “happy” class. As points progress away from 45° toward “calm” or “anxious”, tracks with correspondingly lower probabilities of “happy” and greater probabilities of “calm” or “anxious” are chosen. As points closer to the center are chosen, relatively greater amounts of “neutral” or “sad” will be present in the distribution of the selected track.

Between the initial selection of a track based on a user click in the emotional wheel and any subsequent clicks, the playlisting algorithm will continue to pick songs in the neighborhood of the initial track, where “neighborhood” means those tracks that are nearby the first in a similarity matrix computed from the probability distributions of all songs in the library. The playlisting algorithm gives first priority to maintaining the current emotional quality as requested by the user in the emotional wheel.

The second priority is to maintain a subgenre within the overall library, if the user has selected one (if no genre or sub-genre has been chosen by the user, the algorithm ignores genre in selecting successive tracks). If a sub-genre has been selected, the playlisting algorithm will search for neighboring tracks with the required emotional characteristic within the given sub-genre.

In some instances, there may be legal restrictions on how frequently a song may be played. It may happen then, that a particular combination of sub-genre and emotion is exhausted within the selections available to the system. To handle such cases, the algorithm includes a genre map that indicates which sub-genre or genre to use next should any combination of emotion and genre become depleted. Additionally, the playlisting algorithm makes use of the listener's recorded favorites and bans, such that banned songs, artists, or albums are never added to the playlists of listeners who banned them, and favorite songs, artists, or albums are given additional probability of being chosen. The emotional labels used for the playlisting process are taken either from an individualized matrix of emotional associations and similarities, which will have been generated for those users who have supplied sufficient information to the system, or from a generic set of associations and similarities that was produced by training a classifier from the average of the BIDMC and online responses.

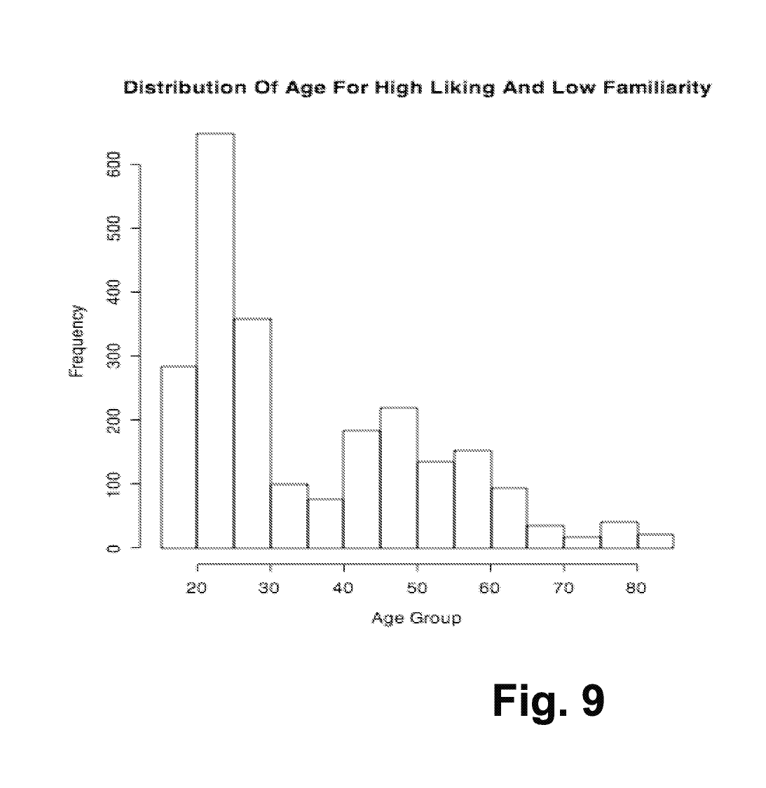

Finally, the playlisting algorithm uses a measure of predicted familiarity to assist in choosing songs that a listener is more likely to enjoy. Familiarity is predicted by looking at a song's release date relative to the listener's date of birth—songs that were released during the listener's teens and twenties are more likely to be familiar. Star ratings and indications of preferred genre are other elements in the familiarity prediction. The playlisting algorithm will tend to select songs that are more likely to be familiar as a function of age—as shown in the graph of FIG. 9, our research demonstrates that younger listeners are more likely to be receptive to material that they have not heard previously. Accordingly, predicted familiarity will play a larger role in playlisting for older listeners than it will for younger ones.

This system is a basic technology that can be applied to a variety of applications in automated content management, medicine, psychology, and entertainment, among other fields. In the area of automated content management, for example, the music classification system technology can be used to automatically sort, search, and organize large music collections, as well as suggest to the user additional material with particular emotional characteristics.

The problem has not been completely solved in the prior art because the solutions developed to date do not take into account a sufficiently developed model of human musical understanding; do not automate that model using both audio features and subject data to generate classifications; do not characterize changes in emotional response over time; do not produce playlists based on a similarity metric that includes relative information from five classes per track; and have not tested their approaches against a broad range of music and subject responses.

The Microsoft system, for example, uses only audio features and no subject information to produce classifications in four discrete categories [Lu & Zhang 2006]. Embodiments of the present invention, on the other hand, use a highly developed model of musical understanding, have automated the model to generate classifications from both audio features and subject data, characterize changes in emotion over time, use a representation that includes information from five classes for playlist generation, and have been tested against a broad range of music and subject responses.

Most extant systems use three general classes of features for music classification purposes: low-level (or audio) features, high-level (or symbolic) features, and cultural features. Embodiments of the present invention go beyond these predecessors in making significant use of a fourth class of information, gathered from the listeners themselves: demographic features. In these embodiments, audio features and demographic features are used together to predict the emotional response of a given listener to any piece of recorded music. Moreover, as a listener provides incremental information about himself, and additional emotional ratings of songs, the system learns a more refined and more accurate model to predict that listener's reaction to subsequent music.

The present invention can identify features from arbitrary audio files, combine the features with information about listeners, and use the combination to predict emotional responses for specific listeners. Prior solutions rely on users to manually input emotional categories for each track, or estimate generic emotional categories using audio information only. They do not provide estimates of changing emotional responses over time. Moreover, the present invention can incrementally learn more accurate predictions for each user by training a new classifier based on demographic information and song classifications provided by that user as he interacts with the system.

The present invention learns to predict a user's emotional response to an audio file. Using 10-fold cross-validation, the current performance of the system is 75% accuracy on a representative test set. The generalized version of the system is used to create playlists for listeners when they first enter the system—as they subsequently provide information about themselves, their musical preferences, and their emotional responses, the system creates a classifier that is more accurate for their particular tastes.

The graph of FIG. 8 is a three-dimensional LDA projection of the feature space: high arousal—high valence (red), low arousal—high valence (pink), low arousal—low valence (cyan), high arousal—low valence (green), and center values (blue). It demonstrates how linear discrimination successfully manages to separate the five mood classes that we have defined in a three dimensional projection of our feature space. The separation demonstrates that these five mood classes, as identified by the subject population, can be uniquely identified using audio data.

Other results include time-varying emotion representations for over 7000 tracks in the current library, similar to the one shown in FIG. 7. These representations currently synthesize the responses from BIDMC subjects, and will be extended with additional ratings from online subjects as the web service becomes publicly available online.

The graph of FIG. 9 is a result from the first phase of testing at BIDMC that demonstrates by age group how often subjects said they highly preferred a song even though they were unfamiliar with it. This demonstrates that subjects below the age of thirty are by far the most likely to prefer music they have not heard previously. This result is used in the playlisting algorithm, in which we use a prediction of familiarity to help determine successive songs. Older listeners are more likely to hear songs with which they are already familiar, while younger listeners will be given a larger percentage of new material.

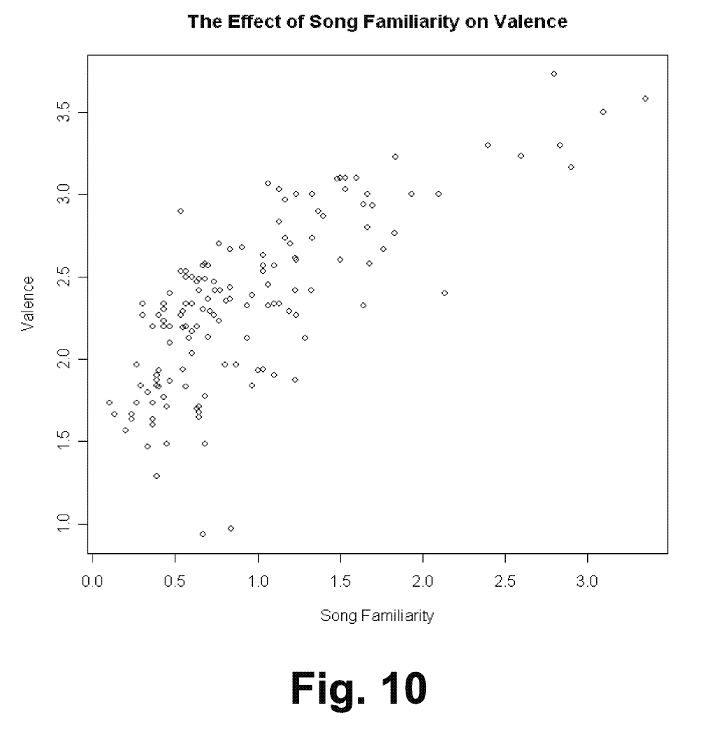

Familiarity is important not only for how much a subject will prefer a song, but for how a subject will rate the valence (positive/negative) of that song (see the graph of FIG. 10, illustrating the effect of song familiarity on valence). As we see, there is a strong correlation between how familiar a subject is with a given song and how likely they are to give it a high valence score. We use this chart in the inverse sense to assist in computing the likelihood of familiarity—that is, the higher the valence, the more likely a subject is to have heard the song previously. We use this heuristic only in those cases where a subject has not explicitly noted his level of familiarity with a track, e.g. when using the radio interface. BIDMC subjects and those using the online version of the test (FIG. 6) are always prompted to record their level of familiarity.

Although preferred embodiments of the invention have been disclosed for illustrative purposes, those skilled in the art will appreciate that many additions, modifications and substitutions are possible without departing from the scope and spirit of the present invention as defined by the accompanying claims.

### REFERENCES

Gjerdingen, R., Khan, R. M., Mathys, M., Pirkner, C. D., Rice, P. W., and Sulzer, T. R. 2000. Method for creating a database for comparing music. U.S. Pat. No. 6,539,395
Gjerdingen, R., Khan, R. M., Mathys, M., Pirkner, C. C., Rice, P. W., and Sulzer T. R. 2000. System for content based music searching. U.S. patent application Ser. No. 9/532,196
Govaerts, S., Corthaut, N., and Duval, E. 2007. “Mood-ex-Machina: Towards automation of moody tunes,” Proceedings of the International Symposium on Music Information Retrieval 2007.
Liu, D., Lu, L., and Zhang, H.-J. 2003. “Automatic mood detection from acoustic music data” Proceedings of the International Symposium on Music Information Retrieval 2003.
Lu, L., Liu, D., and Zhang, H. 2006. “Automatic mood detection and tracking of music audio signals,” IEEE Transactions on Audio, Speech, and Language Processing 14:1 pp. 5-18.
Lu, L., and Zhang, H. 2006. Automatic music mood detection. U.S. Pat. No. 7,022,709
McKay, C., and Fujinaga, I. 2006. “jSymbolic: A feature extractor for MIDI files.” Proceedings of the International Computer Music Conference 2006. San Francisco: International Computer Music Association.
Nordoff, P., and Robbins, C. 1977. Creative music therapy: Individualized treatment for the handicapped child. New York: John Day Company, Inc.
Pitman, M., Fitch, B., Abrams, S., and Germain, R. 2001. Feature-based audio content identification. U.S. Pat. No. 6,604,072
Schubert, E. 2004. “Modeling perceived emotion with continuous musical features,” Music Perception 21:4 pp. 561-585.
Skowronek, J., McKinney, M., and van de Par, S. 2006. “Ground truth for automatic music mood classification,” Proceedings of the International Symposium on Music Information Retrieval 2006.
Skowronek, J., McKinney, M., and van de Par, S. 2007. “A demonstrator for automatic music mood estimation,” Proceedings of the International Symposium on Music Information Retrieval 2007.
Smola, A., and Schölkopf, B. 2004. “A tutorial on support vector regression,” Statistics and Computing 14 pp. 199-222.
Tagawa, J., Misaki, M., Yamane, H., Ono, M., and Yagi, R. 2007. Music search system. U.S. Pat. No. 7,227,071
Thayer, R. 1989. The biopsychology of mood and arousal. New York: Oxford University Press.
Yang, Y.-H., Lin, Y.-C., Su, Y.-F. and Chen, H. 2008. “A regression approach to music emotion recognition,” IEEE Transactions on Audio, Speech, and Language Processing 16:2 pp. 448-457.

### Appendix A: Used Audio Features

The features used are the mean and standard deviation of:

Mel Frequency Cepstral Coefficients—20 Bands

Cepstrum and Mel Cepstrum Coefficients (MFCC) (used in Tzanetakis & Cook 2000a; Pye 2000; Soltau 1998; Deshpande et al. 2001): The cepstrum is the inverse Fourier transform of the log-spectrum log(S).

$$Cn = \frac{1}{2 π} {\int }_{ω = - π}^{ω = π} log S ( ω ) exp ( jω n ) d ω$$

We call mel-cepstrum the cepstrum computed after a non-linear frequency warping onto a perceptual frequency scale, the Mel-frequency scale (Rabiner & Juang, 1993). The Cn are called Mel frequency cepstrum coefficients (MFCC). Cepstrum coefficients provide a low-dimensional, smoothed version of the log spectrum, and thus are a good and compact representation of the spectral shape. The are widely used as features for speech recognition, and have also proved useful in musical instrument recognition (Eronen & Klapuri 2000)” [Aucouturier & Pachet 2003 pp. 85-86].

Loudness Measured in Sones—24 Bands

1 sone is the loudness level of a 1 kHz tone at 40 dB SPL. Frequencies in the audible range are divided into 24 bark bands, which correspond to the critical band frequency response areas of the human auditory system. A number of sones are computed per bark band to indicate the perceived loudness in that frequency range.

Overall Loudness

Overall Loudness is a combination of the 24 bark band sone measurements into one overall perceptual loudness value.

Spectral Centroid

Spectral Centroid (Tzanetakis et al., 2001; Lambrou & Sandler, 1998): The Spectral Centroid is the barycentre point of the spectral distribution within a frame.

$$SC = \frac{{\sum }_{k} kS ( k )}{{\sum }_{k} S ( k )}$$

where S is the magnitude spectrum of a frame. This feature gives an indication of the spectral shape, and is classically used in monophonic instrument recognition.

Spectral Spread

Describes the variance from the centroid of the energy distribution. This together with spectral centroid describes a coarse approximation to the spectral shape.

RMS

Root-mean-square (RMS) is a measure of physical amplitude of the audio signal and is computed by taking n measurements, squaring them, taking the mean, and taking the square root of the mean.

High Frequency Content

High Frequency Content sums the energy present in a number of FFT bins, where the energy in each bin is first multiplied by the bin number (thereby emphasizing the high frequencies).

$$HFC = {\sum }_{i = 0}^{N - 1} i \vert x ( n ) \vert$$

RMS and High Frequency Content can be good for characterizing attack transients in the signal, and thus are used extensively for onset detection and beat tracking.

Chroma—12 Bins

Chroma features describe the spectral energy distribution across the 12 pitch classes on the chromatic scale. They are computed from the log-frequency spectrum by calculating the Constant-Q transform and then summing the energy contribution of bins belonging to the same pitch class in different octaves.

Tonal Space—6 Dimensions

This implementation is based on the work in Harte et al. (ACM Multimedia, 2006), where it is demonstrated that, in just intonation and assuming enharmonic equivalence, a Harmonic Network or Tonnetz can be wrapped around the surface of a Hypertorus. The resulting 6-dimensional surface can be described in terms of three circles representing: fifths, major thirds and minor thirds. The tonal centroid features result from the projection of the 12 chroma features into these circles.

Change Detection in Tonal Space (CDTS)

The final feature results form the calculation of the cosine distance between adjacent sets of tonal centroids. Its purpose is to measure harmonic movement, such that big changes in the tonal centroid coordinates (resulting from changes on the harmonic content on the signal) are characterized as large peaks in this function.

1. A method for selecting recorded musical performances to be presented to an individual, the method being performed with the aid of a computer, comprising the steps of:
maintaining in a form accessible to the computer a general database of musical performances classified in accordance with their impact on listeners in a plurality of predefined categories;
upon a musical performance being presented to an individual, obtaining individual information from him related to its impact on him in the predefined categories;
maintaining in a form accessible to the computer a customized database of musical performances classified in accordance with their impact on the individual and based upon the obtained information;
selecting a performance to be presented to the individual based upon at least one category of the classification of the performance in the customized database.

2. The method of claim 1, wherein the musical performance is a portion of a complete performance.

3. The method of claim 1 wherein the impact is emotional impact.

4. The method of claim 1 wherein performances are classified by assignment to predefined categories.

5. The method of claim 4 wherein performances are classified by assignment of a value in a category.

6. The method of claim 1 wherein performances are classified by being mapped to a multi-dimensional space in which each dimension is a category and the value of a dimension is a ranking in that category.

7. The method of claim 1 wherein the individual information includes the individual's classification of the musical performance.

8. The method of claim 7 wherein the individual information includes the individual's musical experience and education.

9. The method of claim 7 wherein the individual information includes the individual's knowledge of or experience with the musical presentation being presented.

10. The method of claim 1 wherein the selecting step includes predicting the impact on the individual based upon at least one category of the classification of the performance in the customized database.

11. The method of claim 1 or 10 wherein the general database is used in the selecting step in place of the customized database if information has not previously been obtained from the individual with respect to a musical performance to be presented.

12. The method of claim 1 or 10 wherein the customized database is compared to the general database in the selecting step if information has not previously been obtained from the individual with respect to a musical performance to be presented.

13. The method of claim 1 wherein the individual information is used to update the customized database.

14. The method of claim 1 wherein the individual information is used to update the general database.

15. The method of claim 1 or 10 wherein the selecting step is used to generate a play list of musical performances to be presented to the individual.

16. A system for selecting recorded musical performances to be presented to an individual, the selection being performed with the aid of a computer:
a first database controller, in data communication with the computer, maintaining in a form accessible to the computer a general database of musical performances classified in accordance with their impact on listeners in a plurality of predefined categories;
an interrogator, in data communication with the computer and responsive to a musical performance being presented to an individual, obtaining individual information from him related to its impact on him in the predefined categories;
a second database controller, in data communication with the computer, maintaining in a form accessible to the computer a customized database of musical performances classified in accordance with their impact on the individual and based upon the obtained information;
means for selecting a performance to be presented to the individual based upon at least one category of the classification of the performance in the customized database.

17. The system of claim 16 wherein data communication is provided via a network to which the computer is connected.

18. The system of claim 16, wherein the musical performance is a portion of a complete performance.

19. The system of claim 16 wherein the impact is emotional impact.

20. The system of claim 16 wherein performances are classified by assignment to predefined categories.

21. The system of claim 20 wherein performances are classified by assignment of a value in a category.

22. The system of claim 16 wherein performances are classified by being mapped to a multi-dimensional space in which each dimension is a category and the value of a dimension is a ranking in that category.

23. The system of claim 16 wherein the individual information includes the individual's classification of the musical performance.

24. The method of claim 23 wherein the individual information includes the individual's musical experience and education.

25. The method of claim 23 wherein the individual information includes the individual's knowledge of or experience with the musical presentation being presented.

26. The system of claim 16 wherein the means for selecting predicts the impact on the individual based upon at least one category of the classification of the performance in the customized database.

27. The system of claim 16 or 25 wherein the means for selecting uses the general database in the selecting step in place of the customized database if information has not previously been obtained from the individual with respect to a musical performance to be presented.

28. The system of claim 16 or 25 wherein means for selecting compares the customized database to the general database in the selecting step if information has not previously been obtained from the individual with respect to a musical performance to be presented.

29. The system of claim 16 wherein the second database controller uses individual information to update the customized database.

30. The system of claim 1 wherein the first database controller uses individual information to update the general database.

31. The method of claim 16 or 25 wherein the means for selecting generates a play list of musical performances to be presented to the individual.
